(19) United States
(12) Patent Application Publication
(10) Pub. No.: US 2017/0008797 A1
(43) Pub. Date: Jan. 12, 2017

(54) METHOD AND DEVICE FOR PASSIVATING THE INNER SURFACE OF A GLASS FLASK, AND FLASK OBTAINED WITH SUCH A METHOD

(71) Applicant: GLASS SURFACE TECHNOLOGY, Paris (FR)

(72) Inventor: Christophe Wagner, Paris (FR)

(73) Assignee: GLASS SURFACE TECHNOLOGY, Paris (FR)

(21) Appl. No.: 15/119,212

(22) PCT Filed: Feb. 18, 2015
(86) PCT No.: PCT/FR2015/050395

§ 371 Date: Aug. 16, 2016

(30) Foreign Application Priority Data
Feb. 18, 2014 (FR) 1451304

(51) Int. Cl. C03C 21/00; A61J 1/14

(52) U.S. Cl. CPC C03C 21/006; A61J 1/1468

(57) ABSTRACT

The present invention relates to a method, a device for implementing the method, and a flask obtained by said method for passivating the inner wall of a glass container capable of containing a pharmaceutical grade material. To treat or inhibit the inner surface of the container, said inner surface of the container is treated via ion exchange between the container and an aqueous extraction liquid such that the measured hydrolytic resistance of said surface is divided by at least two.

The present invention relates to a process and a device for passivation of the inner surface of a glass bottle.

It also relates to a bottle obtained with such a process.

The term “passivation” is understood to mean an extraction, prior to the use of the bottle, of the elements capable of coming out of the inner wall of the bottle during contact with the products that will subsequently be stored therein.

The extraction must be sufficient so that the weight measurements of these elements are below a given threshold set by the current standards.

It finds a particularly important, but not exclusive, application in the field of container-content interactions and more particularly that of storing pharmaceutical or cosmetic products in glass bottles, in which field it is necessary to be able to store said medicinal and/or cosmetic products in a neutral manner for a given time which may be quite long (for example several months).

Conventionally, the expression “neutral glass” is understood to mean a glass that, over time, releases very few sodium ions or other alkali metal ions and/or alkaline-earth metal ions into the liquid or product that is inside the container.

Soda-lime glass is not for example neutral within the pharmacopeia meaning.

But the invention can also be applied to other fields, such as the agri-food field.

It is known for example that when a glass bottle is manufactured it is inevitably brought to high temperatures.

These give rise in particular to a migration of the alkali metals (in the case of a silicate glass) which rise to the surface of the glass and/or to the immediate vicinity thereof, in a manner sufficient to be subsequently exposed to the contents of the container.

The amounts of alkali metal, although in general very small, are a nuisance in the case of bottles intended to contain vaccines or active principles, which must remain pure.

Indeed, the alkalinity may give rise to disastrous effects on a pharmaceutical product, due to unacceptable reactions that could occur between the wall of the glass and the product.

Means for avoiding drawbacks of this type via the use of sulfur dioxide and/or difluoroethane are already known.

The treatment may also be carried out during the very production of the glass, where precursors are introduced into the furnace that will make the glass obtained less susceptible to this migration.

But, more generally, the conventional treatment carried out by glass producers consists in treating glass bottles at high temperature, on the production line, either with sulfur, or with fluorine, which gives the reaction (1):

2Na+(glass)+(NH₄)₂SO₄ (powder)=Na₂SO₄+2H+(glass)+2NH₃.

The sodium sulfate (white bloom on the inner surface of the bottles) is then washed with water before filling.

There are also (WO 2009/116300 A1, WO 2010/038776 A1) processes for preparing bottles that provide a continuous series of steps that comprise, between the molding of the glass bottles at high temperature and the reheating thereof in order to release the stresses, a cooling step and an internal washing step at temperatures of the glass that may reach 350° C.

An acidic aqueous mixture in the presence of a surfactant is used here for the washing.

Such processes, on the one hand, are only provided with heated new glass bottles and, on the other hand, require the use of acidic aqueous mixtures with surfactant products, that are always complicated to use, within the context of a continuous process incorporating the manufacture of the bottles themselves.

Finally, it is also known to use the covering of the inner wall of the bottle with a thin protective film obtained by vacuum plasma treatment.

All these processes have drawbacks.

In general, they require complex and expensive equipment. They are complicated to implement (the sulfur treatment requires, for example, the use of gas or powder that is difficult to handle) and are not always sufficiently reliable.

The present invention aims to provide a process, a device and a bottle obtained by such a process, corresponding better than those previously known to the requirements of the art, in particular in that it does not give rise to a release of harmful products in order to passivate or protect the inner wall of the bottle or of the container, in that it does not require harsh treatment or obligatory rinsing before and/or after use and in that it makes it possible to treat all types of bottles, independently of the suppliers thereof, while breaking or damaging fewer containers than in the prior art.

In order to do this, the invention starts from the idea of using the chemical reactions of water with the inner wall of the glass container, which reactions take place with all products that contain water (including moist air and steam).

The fact of using the vector of water as main extraction element has never been envisioned since it is conventionally considered to be an inadequate process, water being reserved instead for the washing.

The invention therefore proposes a process that is based on greater or lesser activation of these reactions, taking into account the composition and the concentration of alkali metal of the inner face of the glass bottle, so as to enable ion exchanges between the container and water.

These are carried out on the basis of the following reaction (2):

2SiO₃—O—Na+(glass)+H+OH (solution)→2SiO₃—OH (glass)+Na+OH— (solution)

The glass is then dealkalized at the surface, the Na+ and H+ ion exchange releasing OH— ions into the solution.

There is then an increase of the pH equally of the glass as it is, which is not weakened by this exchange.

After treatment and as a function of the storage conditions (humidity and temperature), the appearance of soluble crystals at the surface of the glass is in general then observed.

This appearance is also described as exudation and is formed with the alkali metals and/or alkaline-earth metals according to the following reaction (3):

Na+ and Ca++(glass)+H₂O (humidity) and CO₂ (from the air)→Na₂CO₃+CaCO₃

The composition of the glass, and in particular the amount of alkali metals and alkaline-earth metals that it contains, naturally have an influence on the water resistance and on the exudation.

On the other hand, when the pH of the solution in contact with the glass is greater than 10, an attack of the strong bonds of the network occurs according to the following balanced reactions (4):

$$\frac{\begin{matrix}Si \text{—} O—Si + OH— -> Si—OH + Si—O—H—OH + \\ Si— O — -> Si— OH + OH—\end{matrix}}{Si— O — Si + H—OH -> 2 Si—OH}$$

Therefore, one objective of the present invention is in particular to implement these principles with the abovementioned advantages while overcoming the drawbacks of the prior art.

For this purpose, it proposes in particular a process for passivation of the inner wall of a glass container suitable for containing a product of pharmaceutical quality, characterized in that in order to passivate and/or inhibit the inner surface of the container, said inner surface of the container is treated by ion exchange between the container and an aqueous extraction liquid so that the measured hydrolytic resistance of said surface is at least halved.

In other words, so that the ability to withstand the release of elements is multiplied by at least two.

Such a result is obtained without subsequent treatment and under appropriate storage conditions, the measurements being carried out for example by means of the determination methods provided by the ISO 4802-2 standard, or by titration according to the ISO 4802-1 standard.

Conventionally, the hydrolytic resistance is measured before treatment, and after treatment, by determination of the amount of sodium oxide and other alkali or alkaline-earth metal oxides released during treatment in an autoclave at 121° C. for 60 minutes, the measurements for example then being carried out in a manner known per se by flame spectrometry.

With the invention, it is thus observed that subsequent releases, in particular as tested in a standardized manner in an autoclave as described above, no longer make it possible to measure significant contents of releases.

In advantageous embodiments, use is otherwise and/or additionally made of one and/or other of the following arrangements:
the aqueous extraction liquid is water of R1 quality.

It is known that water of R quality corresponds to water purified by distillation, ion exchange, reverse osmosis or by any other appropriate method, starting from water intended for human consumption.

Conductivity of such water is less than 4.3 ρS·cm⁻¹ at 20° C. and less than 5.1 ρS·cm⁻¹ at 25° C., the limit of the total organic carbon being set at 0.5 mg/l. Furthermore, R water should comprise less than 0.1 ppm of heavy metals (Pb) and less than 0.2 ppm of nitrate.

Water of R1 quality is itself an R water that is decarbonated by boiling for 15 minutes, or by any other appropriate method. Its resistivity should at least be 1 MΩ·cm, i.e. a conductivity of less than 1 μS·cm⁻¹;
the inner surface of the container is treated by at least three passes of the bottle in an autoclave at a temperature above 120° C., each time for a time greater than one hour, the aqueous extraction liquid also being changed each time.

The idea here is to use the autoclave, which has up to now only been used for taking measurements, industrially as an actual repeated treatment (i.e. repeated more than three times in succession, for example five or ten times).

The water inside the autoclave specifically enables the desired chemical reaction, while maintaining the extraction liquid in liquid form at higher temperature owing to the pressure (which proves to be highly effective);
the extraction liquid is an acid aqueous solution with a pH corrected to 8. Corrected to 8 is understood to mean that the pH of the extraction liquid is brought to 8 by addition of sodium hydroxide or potassium hydroxide. The acid is for example citric acid or acetic acid;
in order to carry out the ionic treatment, the container being a bottle for example, the following steps are carried out at least once:

the inner face of the bottle is bought into contact by filling, vaporization or flowing of the aqueous extraction liquid in the bottle,

the temperature of the bottle is raised with the extraction liquid inside the container and/or while maintaining a saturated atmosphere inside the container up to a given temperature greater than or equal to 80° C. and for a first given time set to avoid thermal shocks and to respect the internal stresses of the bottle,

the bottle is maintained at this temperature for a second given time greater than or equal to 30 minutes (for example 1 to 2 hours), the inside of the bottle being kept entirely in contact with said liquid and/or said saturated atmosphere,

the bottle and the extraction liquid, and/or the saturated atmosphere inside, are cooled for a third given time set to avoid thermal shocks and to respect the internal stresses in the bottle, and

the extraction liquid is emptied if it has not been evaporated in a preceding step.

A saturated atmosphere is understood to mean an atmosphere 100% laden with extraction liquid, this being maintained for a time set in order to guarantee a contact time sufficient for the extraction of the alkali metals from the glass inner wall of the bottle or container.

It should be noted that by maintaining the temperature for a time greater than 30 min, this saturation is guaranteed if the bottles are filled at the start and/or are sufficiently vaporized;
the extraction liquid being acid (for example acetic acid), the liquid is sprayed as a mist inside the bottle, at a temperature greater than 80° C. (for example 95° C.) for the second given time which is greater than 30 min;
the extraction liquid is introduced into the container in the form of ice;
the liquid is sprayed into the container;
the rise in temperature is carried out by a saturated-atmosphere electric annealing lehr.

The invention also proposes a device that implements the process as described above.

The invention also proposes a device for passivation of the inner surface of glass bottles, characterized in that it comprises

means for filling and/or vaporization of an aqueous extraction liquid in the bottles,

a furnace or an annealing lehr,

means for keeping the atmosphere of the lehr saturated with said extraction liquid,

means for transporting said bottles through said lehr for a given time,

means for cooling said bottles, and

means for emptying said bottles if necessary after treatment.

The invention also proposes a bottle obtained by the process described above.

It also relates to a bottle having a free inner surface not treated with, and free of, sulfur and/or fluorine, the measured hydrolytic resistance R_{H} of which is less than 50%, for example 20%, of the lower limit of hydrolytic resistance for the type of glass and given capacity of the bottle corresponding to pharmaceutical use. The expression “pharmaceutical use” is understood to mean the use according to the 8th edition of the European Pharmacopeia published by the European Directorate for the Quality of Medicines & HealthCare.

The term “free” is understood to mean not coated with a protective film.

The expression “not treated with fluorine and/or sulfur” is understood to mean not having undergone the passivations known to person skilled in the art using fluorine and/or sulfur.

Indeed, it is observed that the glass bottles treated according to the invention, for cosmetic, food or pharmaceutical use, have an improved resistance to aging and to moisture from the air, which also makes it possible to avoid the known phenomenon of exudation with air and therefore to be able to use the treated bottles several years after treatments without having to clean them.

They also have a high hydrolytic resistance (the hydrolytic resistance is reduced by 50%, i.e. halved, relative to the untreated bottle) which makes it possible to make contact with the product safe and/or to place in contact with harsher products.

Finally, with the process according to the invention, the bottles obtained have an improved cleanliness of the inner surface, including through the elimination of dust and particles.

Advantageously, the container moreover and/or additionally has an alkali or alkaline-earth metal surface composition, over a thickness e≦10 μm, for example less than 5 μm, for example between 0.01 μm and 0.5 μm, for example between 0.001 μm and 0.01 μm, at least 5% lower than the composition of glass in the bulk.

The invention will better understood on reading the following description of embodiments described below by way of nonlimiting examples and with reference to the accompanying figures in which:

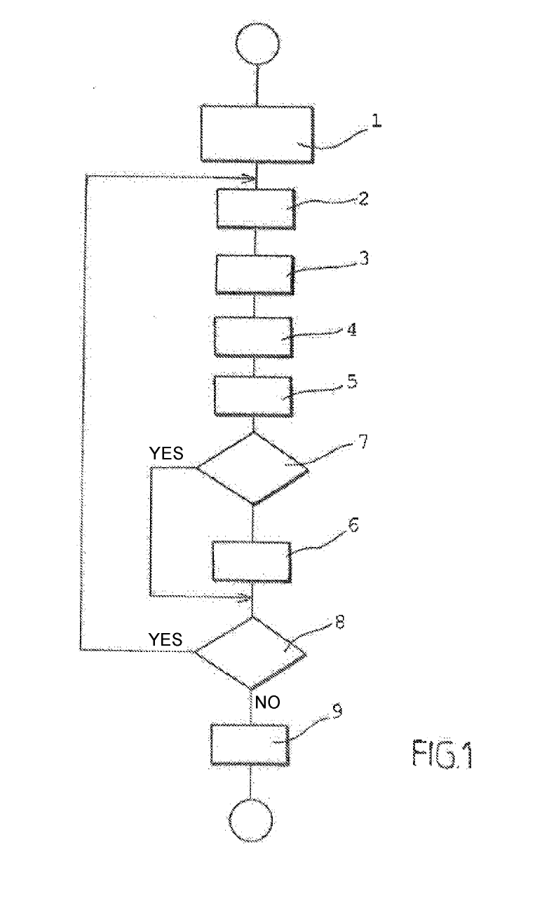

FIG. 1 is a flowchart showing the steps of a passivation process according to one embodiment of the invention.

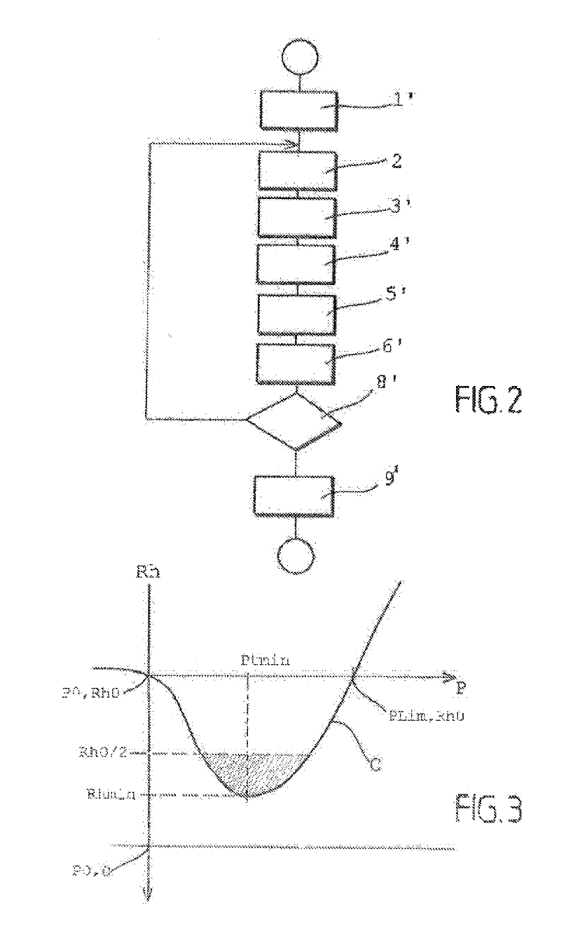

FIG. 2 shows a flowchart of the steps of the process according to another embodiment of the invention.

FIG. 3 shows a curve of the change in the hydrolytic resistance RH as a function of the treatment conditions.

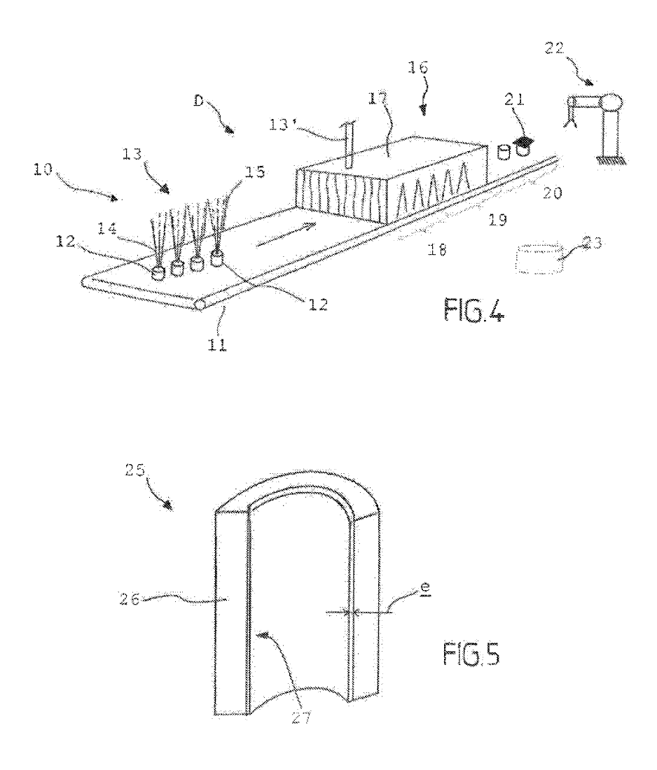

FIG. 4 schematically shows, in perspective, an embodiment of a device implementing the process described with reference to FIG. 1.

FIG. 5 shows, as a partial exploded view, an example of an inner wall of a container according to one embodiment of the invention, as obtained by the process described with reference to FIG. 1.

FIG. 1 shows the steps of the passivation process according to the embodiment of the invention more particularly described here, for the passivation of the inner face of one or more bottles, for example open pharmaceutical bottles, placed on rack-type removable supports.

After a first step 1 of supplying the bottles, these bottles are filled with aqueous extraction liquid (step 2), for example with water of R1 quality.

In an alternative embodiment, the aqueous liquid is sprayed as a mist inside the bottles, in a manner known per se, for example by means of individual nozzles automatically positioned opposite the opening of the bottles.

Spraying is suitable for ensuring a continuous thin film of liquid on a given surface of said bottles, which are then placed in a heated chamber (step 3), which is enclosed and maintained at a given hygrometry of extraction liquid.

The degree of hygrometry is for example 100%. In this way, the contact between the extraction liquid and the inner wall of the bottle is ensured continuously.

The heated chamber is for example an electric and/or gas-fired lehr or furnace. The bottles are then raised to a given temperature of between 70° C. and 150° C., for example 80° C., for a first time, for example of 15 min so as to avoid thermal shocks.

The temperature is controlled in a manner known per se and the bottle is then maintained (step 4) at said given temperature for a second given time, for example 40 minutes.

The bottles are then removed from the furnace (step 5) or from the heating zone thereof, in order to be cooled for a third given time, for example three minutes, here too with kinetics suitable for avoiding thermal shocks.

The final temperature obtained after cooling is for example ambient temperature.

The extraction liquid remaining is then emptied (step 6) if it has not been evaporated (test 7) in a preceding step.

In the embodiment described, steps 2 to 6 are repeated (test 8) for a given number of times, for example twice, so as to obtain a hydrolytic resistance lower than the previously chosen given threshold.

When several repetitions of the process are carried out, the aqueous extraction liquid is changed each time (repetition of step 2).

The bottles are then, but not compulsorily, rinsed then dried (step 9) before being stored for later use.

FIG. 2 gives the steps of the process according to the embodiment of the invention using an autoclave.

This autoclave is of the type known per se.

After a first step of supplying the bottles, these bottles are filled with aqueous extraction liquid and are closed, for example with a non-leaktight aluminum foil (step 2).

Next they are placed in an autoclave (step 3′).

The contents of the autoclave are then brought, while respecting the temperature rise holds for avoiding thermal shocks, to the second given temperature (for example 121° C.) and to the corresponding pressure. It is maintained at these values for the second given time, for example greater than 1 hour (step 4′).

The pressure inside the autoclave is suitable for keeping the extraction liquid in the liquid phase. For example for 121° C., the pressure is increased by 1 atm (atmosphere) relative to the ambient atmospheric pressure.

The temperature of the bottles is then lowered, for example to 80° C., while respecting the stresses of the glass (step 5′).

The bottle is then emptied of its contents (step 6′) and steps 2′ to 6′ are repeated (line 7′) a number of times greater than three, for example five times or ten times (test 8′).

The bottles are then drained after an optional rinsing (step 9′).

Represented in FIG. 3 is the influence of the parameters P of the process on its efficiency.

The parameters P are the various given temperatures and times of the process, the pressure conditions used and the composition of the extraction liquid.

The curve C represents the change in the hydrolytic resistance (RH) of the inner walls of the bottles as a function of these parameters.

The greater the values of one or more of the parameters, the more aggressive the treatment and the faster the treatment kinetics.

Knowing that for a given glass and standard usage conditions PO (namely ambient atmospheric pressure and temperature), for water of domestic quality, the glass has a hydrolytic resistance Rh0 referred to as the reference hydrolytic resistance.

After treatment, as a function of the increase in the value of the parameters P, the hydrolytic resistance obtained for the treated glass Rh follows the curve C to a minimum Rmin (for parameters Ptmin).

The minimum resistance Rh then corresponds to a minimum subsequent release of elements from the glass into the contents.

It is less than Rh0/2.

But it is observed that an increase in the value of one of the parameters, relative to the minimum point Ptmin of the aggressiveness, on the other hand makes the hydrolytic resistance rise until it again passes through Rh0 for parameters PLim.

It is also observed that if the aggressiveness of the parameters is increased again beyond the limit PLim, the hydrolytic resistance is then deteriorated (due to the deterioration of the glass itself).

The invention proposes a process that makes it possible to remain within the (inverted) peak of the curve C (hatching in the figure).

An embodiment of a device D implementing the process from FIG. 1 will now be described with reference to FIG. 4.

The device D first of all comprises means 11 for transporting the bottles 12, such as for example a conveyor belt.

The bottles 12 are for example placed individually on the conveyor belt 11, or inserted into supports (not represented).

Means 13 for filling and/or vaporization/spraying of the aqueous extraction liquid 14 in the bottles are provided.

These means are known per se.

They are for example formed by injection nozzles 15, which fill or spray a given amount of liquid 14 in each of the bottles, for example by filling them to at least 80% of their volume.

The aqueous extraction liquid is for example water of R1 quality or citric acid-water with a pH corrected to 8.

In another embodiment, the extraction liquid is introduced into the bottles in the form of crushed ice which, for a given boiling temperature, lengthens the contact time between the liquid and the inner wall and protects from thermal shocks.

The device D comprises, positioned downstream of the filling zone on the conveyor belt, a furnace 16.

The furnace 16 is for example a heated saturated-atmosphere electric annealing lehr 17 that is known per se, that has heated curtains and that is in the form of a tunnel through which the bottles are therefore slowly made to pass.

The hot zone successively comprises, in the direction of the operation of the conveyor belt, a first subzone 18 for raising the temperature, a second subzone 19 for maintaining a given temperature and a third subzone 20 for cooling down to ambient temperature.

The conveyor belt 11 thus introduces the bottles 12 into the first subzone 18 of the annealing lehr 17 which gradually raises the temperature to a first given temperature, for example of 80° C.

The conveyor belt 11 then introduces the bottles 12 into the second heating subzone 19 that also comprises means 13′ for keeping the atmosphere of the lehr saturated with the extraction liquid.

These means 13′ comprise means for controlling the chamber of the furnace 17 and for supplying it with extraction liquid.

In some embodiments, the extraction liquid 14 is acetic acid introduced as a mist inside the chamber and therefore the bottles, at a temperature greater than 80° C. (for example 95° C.) for the second given time which is greater than 30 min.

But provision may also be made for injection nozzles (not represented) for injection of the acid mist, placed directly inside the hot zone (furnace or lehr).

The conveyor belt 11 has a suitable speed and/or a suitable length so that the bottles 12 remain in said lehr 17 for a given time, in particular at the desired operating temperatures.

The conveyor belt 11 makes the bottles 12 pass through the third hot subzone 20 comprising means for cooling said bottles.

These means (not represented) may be in the open air or under a controlled atmosphere. Here the control (start/stop), the speed and/or the length of the conveyor about 11 must allow a temperature rise/drop that is slow enough to prevent thermal shocks but suitable for the reaction kinetics.

The operation of the conveyor belt is therefore programmed and controlled accordingly.

In one embodiment, the bottles are emptied after treatment and closed for example with an aluminum foil 21 during the drop in temperature thereof, which will make it possible to keep their inner wall in an aseptic environment.

At the end of travel of the belt 11, the device also comprises, if necessary, means 22 that make it possible to tip over the bottles in a manner known per se, in order to empty them for example above a storage tank 23, before placing them in another work station.

The other work station may be a packaging unit.

It may also be a unit for rinsing the bottles when necessary, in particular if emptying was required.

On the other hand, if there is, along the path of the conveyor belt, a temperature zone greater than the boiling point of the extraction liquid, for a sufficient time, the bottle 12 will a priori have no need of a rinsing step.

It may finally be another treatment device D and/or gripping means that make it possible to place the bottles back at the start of the line in order to repeat the treatment a given number of times.

A bottle according to one embodiment of the invention will now be described with reference to FIG. 5.

The bottle 25 (represented as a partial, exploded, cross-sectional view) is formed of glass 26 constituted of a chemical network, of which forming ions provide the structure, and modifying ions, of weaker chemical bond with the network, and which form the elements (residual chemical species released) of which the invention proposes in particular to reduce the amount released.

For example, the forming ions are SiO₂, Al₂O₃ present at close to 74% of the total mass and B₂O₃ present at close to 12%.

The network-modifying ions are for example Na₂O and/or K₂O up to the remaining percentage.

While the surface is in contact with the liquid, a substitution reaction takes place in the glass between the hydrogenated ions of the liquid solution and the other ions of the glass.

Thus, the inner surface 27 of the container 25 carries out an ion exchange between the container and an aqueous extraction liquid 14 so that the hydrolytic resistance of said surface 27 is at least halved in absolute terms (resistance capacity multiplied by 2).

The ion exchange thus produces a passivation of the container.

The bottle from FIG. 5 was treated by a process according to the invention.

It has a free inner surface 27 which was depleted of releasable chemical elements over a very thin thickness e for example of less than 10 μm.

If said bottles 25 are subsequently not treated, they are then free of sulfur and/or fluorine, and have a hydrolytic resistance R_{H} of less than 50% of the lower limit indicated by the European Pharmacopeia for this type of bottle and glass.

Depending on the quality of the glass initially supplied, the bottles, after treatment by the invention, have a hydrolytic resistance of the inner wall at the very least of less than 20% of the lower limit indicated by the European Pharmacopeia.

Given in the table below are the results of measurements carried out, following the standardized ISO measurement protocol already mentioned with various treatments according to the invention:

TABLE

| | | | | Difference |
|---|---|---|---|---|
| | | | | between the |
| | Treatment | RH | Average | average and the |
| Test | conditions | results | RH | reference |
| 0 | Reference | 0.2 | 0.14 | 0.00 |
| | | 0.1 | | |
| | | 0.15 | | |
| | | 0.14 | | |
| | | 0.12 | | |
| | | 0.13 | | |
| | | 0.15 | | |
| | | 0.14 | | |
| | | 0.16 | | |
| | | 0.19 | | |
| | | 0.12 | | |
| | | 0.13 | | |
| 1 | ice - capped bottle/ | 0.1 | 0.09 | −0.05 |
| | introduction at | 0.1 | | |
| | 20° C., increase to | 0.08 | | |
| | 600° C. at 300° C./h | | | |
| | (hold 30 min at 600° C.) | | | |
| 2 | Acetic mist, 20 min | 0.06 | 0.06 | −0.08 |
| | | 0.06 | | |
| | | 0.06 | | |
| 3 | Acetic mist, 30 min | 0.04 | 0.06 | −0.08 |
| | | 0.12 | | |
| | | 0.01 | | |
| 4 | 3% citric acid, pH = | 0.11 | 0.11 | −0.03 |
| | 8, oven 80° C. 24 h, | 0.12 | | |
| | Al-capped bottle | 0.1 | | |
| 5 | 3% citric acid, pH = | 0.12 | 0.11 | −0.03 |
| | 8, oven 90° C. 24 h, | 0.14 | | |
| | Al-capped bottle | 0.07 | | |
| | | 0.42 | | |
| | | 0.52 | | |
| 6 | 0.1N NaOH, 24 h 00 | excess | 0.11 | −0.03 |
| | at ambient | 0.11 | | |
| | temperature (capped | 0.1 | | |
| | bottle) | | | |
| 7 | Autoclave, R1 water - | 0.1 | 0.05 | −0.10 |
| | 121° C. three cycles | 0.03 | | |
| | | 0.07 | | |
| | | 0.07 | | |
| | | 0.08 | | |
| | | 0.03 | | |
| | | 0.03 | | |
| | | 0.02 | | |
| | | 0.04 | | |
| | | 0.03 | | |
| | | 0.05 | | |
| | | 0.03 | | |
| | | 0.02 | | |

Each implementation corresponds to specific parameter conditions specified in the “Test conditions” column.

For each “RH results” line, the value of a hydrolytic resistance measurement carried out (for example there were 13 measurements for test 7) is expressed.

For a same “test”, the measurements are averaged in the “Average RH” column. Each average is compared with the reference measurement from “test 0” and the difference between the two appears in the “Difference between the average and the reference” column.

The reference conditions are those considered above to be the standard conditions giving a base hydrolytic resistance R0, with a bottle stored empty after cooling for several weeks (having from that moment undergone a natural aging under relatively long standard conditions of storing in open air).

After filling with water under the standardized conditions, the test mentioned above is then carried out with measurement of the pH.

In the tests carried out as described with reference the table, everything which is extracted from the glass is measured, including the silica which constitutes a good portion thereof, and more specifically all the alkali metals, alkaline-earth metals, and also the forming ions (and not only sodium).

In other words, it is a measurement that makes it possible to determine everything released independent of the amount of sodium.

A negative result of the difference indicates that the treatment carried out under the conditions indicated improved the hydrolytic resistance of the bottle considered.

Conversely, a positive result would indicate a degradation.

Thus, the measurements carried out reveal that the embodiment from test 7, in which the process is carried out by an autoclave with water of R1 quality at 121° C. for three one-hour cycles makes it possible to reduce the hydrolytic resistance by almost three times and therefore to make it almost three times better.

As goes without saying and as also results from the aforementioned, the present invention is not limited to the embodiments more particularly described. On the contrary it encompasses all the variants and especially those where the number of cycles, the temperatures, the pressures, and the durations are determined differently, as a function of the glass and of the desired results, those where the container is a pot or another glass container, and those where the hot subzones themselves comprise subzones for varying the temperature below and/or above said temperatures.

1. A process for passivation of the inner wall of a glass container suitable for containing a product of pharmaceutical quality, wherein in order to passivate and/or inhibit the inner surface of the container, the process includes treating said inner surface of the container by ion exchange between the container and an aqueous extraction liquid so that the measured hydrolytic resistance of said surface is at least halved.

2. The passivation process as claimed in claim 1 wherein the aqueous extraction liquid is water of R1 quality.

3. The passivation process as claimed in claim 1, wherein the inner surface of the container is treated by at least three passes of the bottle in an autoclave at a temperature above 120° C. for a time greater than one hour, the aqueous extraction liquid being changed each time.

4. The passivation process as claimed in claim 1, wherein the extraction liquid is an acid aqueous solution with a pH corrected to 8.

5. The passivation process as claimed in claim 1, wherein, the container being a bottle, in order to carry out the ionic treatment the following steps are carried out at least once:
bringing the inner face of the bottle into contact by filling, vaporization or flowing of the aqueous extraction liquid in the bottle,
raising the temperature of the bottle with the extraction liquid inside the bottle and/or while maintaining a saturated atmosphere inside the container up to a given temperature greater than or equal to 80° C. and for a first given time set to avoid thermal shocks and to respect the internal stresses of said bottle,
maintaining the bottle at this temperature for a second given time greater than or equal to 30 minutes, the inside of the bottle being kept entirely in contact with said liquid and/or said saturated atmosphere,
cooling the bottle and the extraction liquid inside for a third given time set to avoid thermal shocks and to respect the internal stresses in the bottle, and
emptying the extraction liquid if it has not been evaporated in a preceding step.

6. The passivation process as claimed in claim 5, wherein, the extraction liquid being acid, in order to bring the extraction product into contact with the inner wall of the bottle, the liquid is sprayed as a mist inside the bottle, at a temperature greater than 80° C. for the second given time which is greater than 30 min.

7. The process for passivation of the inner wall of a glass container as claimed claim 1, wherein the extraction liquid is introduced into the container in the form of ice.

8. The passivation process as claimed in claim 5, wherein the rise in temperature is carried out by a saturated-atmosphere electric annealing lehr.

9. A device for passivation of the inner surface of glass bottles, comprising:
means for filling and/or vaporization of an aqueous extraction liquid in the bottles and an annealing lehr,
means for keeping the atmosphere of the lehr saturated with said extraction liquid,
means for transporting said bottles through said lehr for a given time,
means for coding said bottles, and
means for emptying said bottles if necessary after treatment.

10. A glass container having a free inner surface not treated with, and free of, sulfur and/or fluorine, the hydrolytic resistance RH of which is less than 50% of the lower limit indicated by the European Pharmacopeia for this type of bottle and glass and the alkali or alkaline-earth metal surface composition of which, over a thickness e≦10 μm, is at least 5% lower than the composition of the glass in the bulk.
